(19) United States
(12) Patent Application Publication
(10) Pub. No.: US 2016/0178057 A1
(43) Pub. Date: Jun. 23, 2016

(54) APPARATUS AND METHOD FOR PROVIDING A VISUAL INDICATION OF SEAL INTEGRITY

(71) Applicant: Caterpillar Inc., Peoria, IL (US)

(72) Inventors: Christian Sabotta, Washington, IL (US); Jay Cline, Hopewell, IL (US)

(73) Assignee: Caterpillar Inc., Peoria, IL (US)

(21) Appl. No.: 14/578,527

(22) Filed: Dec. 22, 2014

(51) Int. Cl. F16J 15/06; F16J 15/10

(52) U.S. Cl. CPC F16J 15/064; F16J 15/108; F16J 15/102

(57) ABSTRACT

A seal device includes a seal member configured to seal a first component and a second component and a tab member formed on a seal member perimeter. The tab member is configured to extend substantially outward from the seal member perimeter to a respective component perimeter. The seal member and the tab member are formed from a mixture of a seal compound and a characteristic changing compound. The tab member is configured to provide a visual indication of seal integrity without separating the first component and the second component.

### TECHNICAL FIELD

The present disclosure relates to seal devices and more particularly to a seal device and method for forming a seal device that provides a visual indication of seal integrity, or lack thereof.

### BACKGROUND

Seals are used in numerous applications to prevent a fluid from leaking between two structures. Fluid seals are made of a variety of materials and have a multitude of design configurations. Such seals may begin to fail when exposed to high temperatures or pressures.

U.S. Pat. No. 5,501,945 to Kanakkanatt discloses using dyes in packaging materials that respond to specific stimuli and indicate exposure to stimuli by a change or shift in the frequencies of light which they adsorb. Although the methods disclosed by Kanakkanatt include use of photochromic, chemichromic, or piezochromic dyes to indicate specific changes in the environment of the packaging materials, Kanakkanatt does not disclose using such dyes to detect seal failures for mechanical components. Instead, the dyes are used for verification of heat seal quality to detect whether a packaged food or medical use product has been properly sealed.

The disclosed devices and methods are directed to solve one or more of the problems set forth above and/or other problems in the art.

### SUMMARY

In one embodiment, a seal device is provided. The seal device includes a seal member configured to seal a first component and a second component and a tab member formed on a seal member perimeter. The tab member is configured to extend substantially outward from the seal member perimeter to a respective component perimeter. The seal member and the tab member are formed from a mixture of a seal compound and a characteristic changing compound. The tab member is configured to provide a visual indication of seal integrity without separating the first component and the second component.

In one embodiment, method for visually indicating seal integrity is provided. The method includes mixing a seal compound and a characteristic changing compound. The method further includes forming a seal device using the mixture of the seal compound and the characteristic changing compound. Forming the seal device includes forming a seal member configured to seal a first component and a second component and forming a tab on a seal member perimeter. The tab is configured to extend substantially outward from the seal member perimeter to a respective component perimeter. The tab and the characteristic changing compound provide a visual indication of seal integrity without separating the first and second sealed components.

In one embodiment, a seal device is provided. The seal device includes a seal member configured to seal a first component and a second component. The seal device further includes a tab member formed on a seal member perimeter. The tab member is configured to extend substantially outward from the seal member perimeter to a respective component perimeter and fit within a corresponding tab channel formed within at least one of the first component and the second component. The seal member and the tab member are formed from a mixture of a seal compound, a pressure sensitive compound, and a temperature sensitive compound. The tab member is configured to provide a visual indication of seal integrity without separating the first component and the second component.

### BRIEF DESCRIPTION OF THE DRAWINGS

The accompanying drawings, which are incorporated in and constitute a part of this specification, illustrate several aspects of the disclosure and together with the description, serve to explain the principles of the disclosure. In the drawings:

FIG. 1 illustrates an exploded perspective view of a first structure, a second structure, and a seal of a machine;

FIG. 2A illustrates an exploded perspective view of the first structure and the seal, where the seal is in a first state providing a visual indication of seal integrity;

FIG. 2B illustrates an exploded perspective view of the first structure and the seal, where the seal is in a second state providing a visual indication of possible seal failure due to exposure to at least one of a high pressure or temperature;

FIG. 3A illustrates a side view of an additional structure and seal of a machine, where the seal is in a first state providing a visual indication of seal integrity

FIG. 3B illustrates a side view of the additional structure and seal of a machine, where the seal is in a second state providing a visual indication of possible seal failure due to exposure to at least one of a high pressure or temperature

FIG. 4A is a cross-sectional view of the first structure, second structure and seal, where the seal is in a first state providing a visual indication of seal integrity;

FIG. 4B is a cross-sectional view of the first structure, second structure and seal, where the seal is in a second state providing a visual indication of possible seal failure due to exposure to at least one of a high pressure or temperature; and

FIG. 5 illustrates a flowchart of a method for forming a seal device providing a visual indication of seal integrity according to embodiments of the present disclosure.

### DETAILED DESCRIPTION

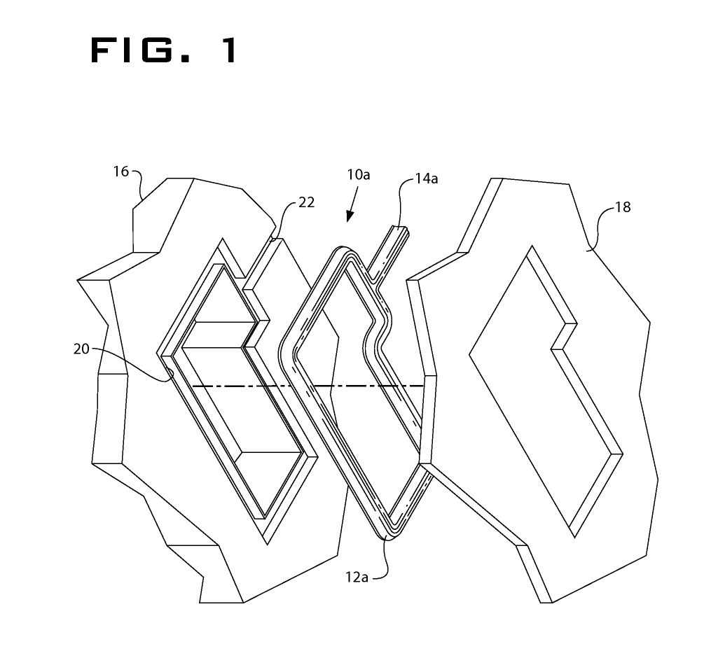

Referring now to FIGS. 1-2B and 4A-4B, one embodiment of a seal device 10a including a seal member 12a and a tab member 14a configured for use with a first structure 16 and a second structure 18 is shown. As used throughout and in FIGS. 1-2B and 4A-4B, seal device 10a including a seal member 12a and a tab member 14a may be used to describe the seal device 10a and its components under typical use conditions, while seal device 10b, seal member 12b, and tab member 14b are used to describe a seal device that has experienced a change in one or more physical characteristics, as will be described herein.

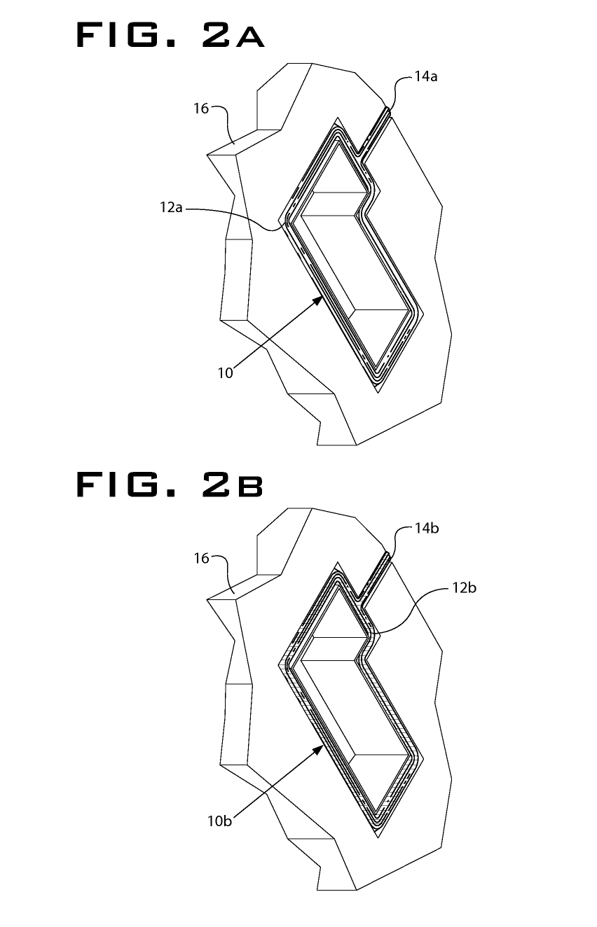

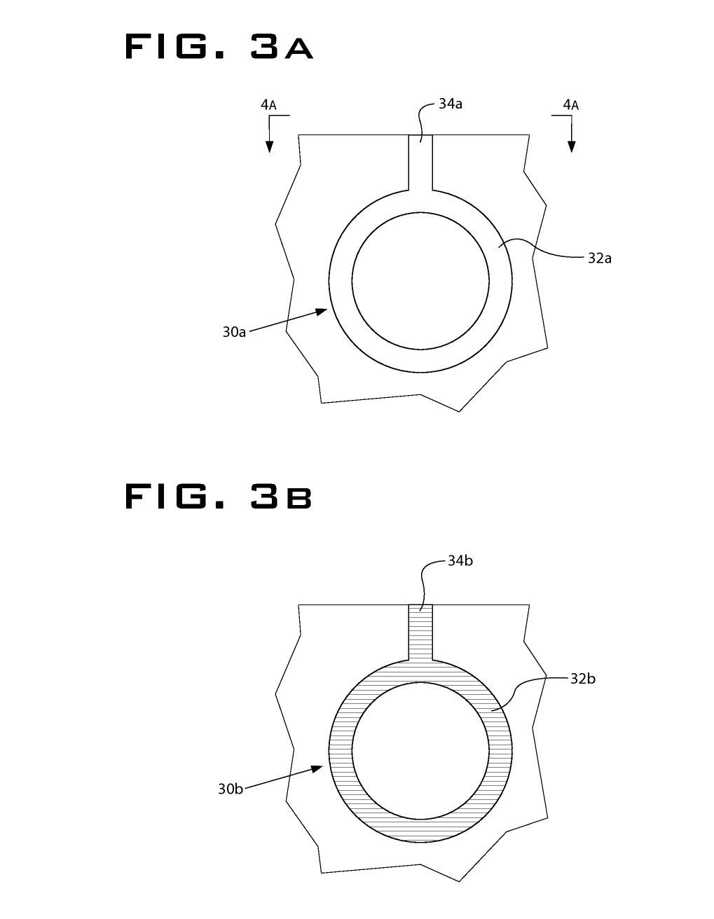

The seal member 12a may generally be formed having a length and a cross section that may be generally uniform along the length of the seal member 12a, though minor dimensional changes of the cross section may occur due to normal manufacturing variability. The seal member 12a may generally include an outer perimeter and an inner perimeter. The seal member 12a may have a multitude of design configurations that include, but are not limited to, an elastomeric O-ring seal, a press-in-place seal, an H-type seal, a washer made of a soft conformable material, a flat gasket made from a soft conformable material, a compression fitting, a circular flared fitting, a threaded pipe fitting, etc. Sealing using conformable materials may be achieved when such material is placed between relatively rigid mating surfaces and that sealing occurs when the material displaces to conform to and fill the space between the mating surfaces. In some embodiments, the seal member 12a may be formed as a continuous core of conformable material. In the embodiments shown in FIGS. 1-2B, seal device 10a includes a seal member 12a having the configuration of press-in-place seal. In an alternative exemplary embodiment shown in FIGS. 3A-3B, a seal device 30a includes a seal member 32a having the configuration of an O-ring and a tab member 34a. It should be appreciated, however, that seal member 12a may take on any desirable sealing configuration. The seal member 12a may also be formed within dimension sizes appropriate for sealing associated components. Additionally, seal member 12a may be made from a single-piece flexible member.

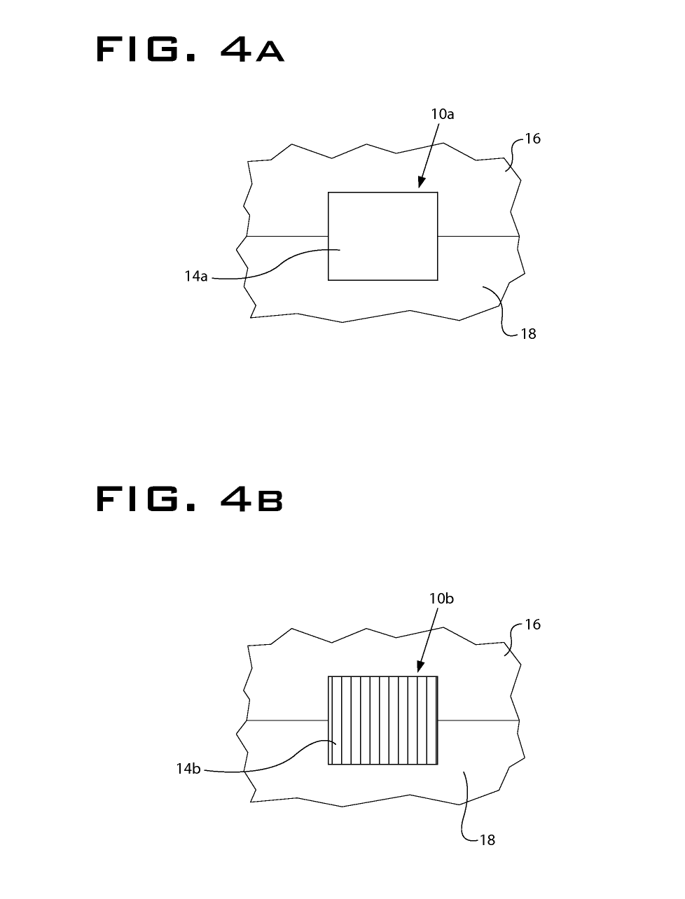

The tab member 14a may extend or project outward substantially away from the seal member outer perimeter to an edge of the one or more sealed components (e.g., first and second structures 16, 18) such that the tab member 14a may be visible when the components are sealed. Thus, the tab member 14a may be configured to provide a visual indication of an alteration in a physical characteristic of the seal upon exposure of the seal to at least one of an unacceptably high temperature or pressure when the seal is in use without separating the sealed components. Referring to FIGS. 4A-4B, a cross sectional view illustrating the seal device 10a installed within the first structure 16 and covered by the second structure 18 is shown. In normal operation, shown in FIG. 4A, (e.g., when the seal member 12a is functioning properly), the characteristic changing material may be inactive, and seal integrity may be indicated by the tab member 14a. However, if a seal failure is detected (e.g., when the seal member 12a is subjected to higher than acceptable pressure or temperature), the characteristic changing material may be activated and, using the exposed tab member 14b, a visual indication of the compromised seal member 12b may be provided (indicated by the vertical stripes applied to the tab member 14b in FIG. 4B) without separating the sealed components. Similarly, in the embodiment shown in FIGS. 3A-3B, when seal device 30a is exposed to higher than normal pressures or temperatures, such exposures may be visually indicated by seal device 30b and its corresponding components, seal member 32b and tab member 34b as shown in FIG. 3B.

With continued reference to FIGS. 1-2B and 4A-4B, the first and second structures 16, 18 may be the components of a mechanical device or machine that can be sealed at an interface of the two. To accommodate the seal member 12a and tab member 14a, the first structure 16 may include a channel 20 surrounding an edge of an aperture of the first structure 16. The second structure 18 may include a corresponding mating aperture and cover the channel 20 when assembled. Accordingly, the seal member 12a (e.g., formed as a continuous core) may be placed into the seal channel 20 of the first structure 16 (or the second structure 18) to provide a seal between the two. At least one of the first and second structures 16, 18 may also include an outwardly projecting channel 22, into which the tab member 14a may fit. While channels 20, 22 are shown having a substantially rectangular cross section, the channels 20, 22 and corresponding seal device 10a may be any shape suitable for performing the function of a seal for sealing mechanical components. In normal operation and as installed, the sealing contact face of the seal member 12a will form a fluid seal with a corresponding sealing contact face of the mechanical components being sealed.

To provide a visual indication of instances when the seal device 10a is exposed to a higher than acceptable temperature and pressure (based on normal thresholds for the seal device 10a), the material used to form the seal device 10a may include a mixture of a conformable seal compound and a characteristic changing material. A known seal compound used for forming the seal device 10a, or any of the components forming the seal device 10a (e.g., seal member 12a, tab member 14a) may include a variety of seal forming materials. For instance, the seal compound or material used to form the seal device 10a may be an elastomeric or polymer based material, cellulose, thermoset rubber, acrylic, composite, polyacrylic, or other flexible sealing material of known art.

The characteristic changing material may be a reactive substance that is mixed with the seal compound for forming the seal device 10a. The reactive substance can be reactive particulates, dyes, liquids and/or powders that are mixed with a seal compound for forming the seal device 10a that change in appearance when certain thresholds are exceeded. Thus, using the characteristic changing material, detecting an undesirable change in seal pressure or temperature may then be made possible by visually detecting a change in a physical characteristic of the seal device 10a (or at least the tab member 14a of the seal device 10a) when the seal device 10a has been exposed to a mechanical stress or temperature above a threshold intensity (shown as seal device 10b and corresponding components seal member 12b and tab member 14b in FIGS. 1-2B and 4A-4B). A mechanical stress or temperature of “threshold intensity” may be defined as the maximum stress or force that can be applied or the maximum temperature to which the material can be exposed, under test or operational conditions, to the seal device 10a (having characteristic changing material), that does not cause the characteristic changing material to change its appearance. A change in appearance may be flexibly defined and includes, for example, a change in the intensity of a color or a hue of color, a change in the absorbance, transmission, radiation, or reflection of a selected wavelength of energy, or a difference in the degree of transparency, whether detectable by a machine or the aided or unaided human eye. Color may be broadly defined to include black, white, and shades of gray; the usual primary (e.g., red, yellow, blue) and mixed colors (e.g., orange, purple, green) of pigments or radiation; and frequencies or mixtures of frequencies of radiation either visible or non-visible to the human eye, thus including visible light, infrared light, ultraviolet light, and other electromagnetic energy. A change of color may include both a change from one color to another and a change from colorless to colored or vice versa.

The seal device 10a may be designed to have a threshold intensity that is no greater than the minimum intensity that would cause the seal device to be rejected as defective or possibly defective due to excessive experienced stress or an excessive increase in temperature. Then, if the seal device so designed is subjected to such excessive stress or temperature and exhibits a change of appearance, this change of appearance indicates that it has experienced a stress or temperature exceeding its threshold intensity. The seal device 10b can be replaced based on detection of the change of appearance. For example, in instances when the strain on the seal device 10a exceeds a max pressure (e.g., sixty three percent for PIP seals, sixty-nine percent for O-ring type seals, or eighty percent for H-type seals), or a max temperature, the seal device 10a and/or the tab member 14a alone may change in appearance. Thus, the characteristic changing material and tab member 14a are configured to provide a visual indication of seal integrity by providing a change in a seal characteristic that may be visible without separating sealed components, as shown in FIGS. 4A-4B. This may be accomplished prior to fluid escaping between the sealing contact face of seal member 12a and sealing contact face.

In some embodiments, the reactive substance may be a thermochromic, piezochromic, or chemichromic compound or dye. In other instances, the reactive substance can include small particles of any pressure sensitive, thermally or chemically reactive material, including, but not limited to, reactive ions, oxidants, acidic materials, caustic materials.

In exemplary embodiments, at least a portion of the characteristic changing material is a thermochromic material. Thermochromic material may be configured to change the one or more frequencies of light which it principally absorbs in response to one or more temperature changes. In some embodiments, the thermochromic dye is a pH-indicator dye or a leuco dye. Thus, thermochromic material can be used to indicate whether the seal device 10a has been exposed to a particular temperature. In any embodiment, the thermochromic material or compound may include one or more of thermochromic pigments or dyes that exhibit a change in absorption spectrum through changes in the pressure applied to them. Thus, at least a portion of the seal device 10a may change its appearance by developing or changing color after exposure to a mechanical stress exceeding a threshold intensity. Accordingly, the color of at least a portion of the thermochromic material (and thus, the seal device 10a or at least a portion of the seal device 10a) may be a color other than a usual seal color after at least a portion of the seal is exposed to the mechanical stress exceeding the threshold intensity (e.g., seal device 10b including seal member 12b and tab member 14b shown as having horizontal stripes in FIGS. 2B and 3B, and seal device 30b including seal member 32b and tab member 34b shown as having horizontal stripes in FIG. 4B). For instance, the color of at least a portion of the seal device 10b may be blue after at least a portion of the seal device 10b is exposed to the mechanical stress exceeding the threshold intensity. In other embodiments, the color of at least a portion of the seal device 10b may be green after at least a portion of the seal device 10b is exposed to the mechanical stress exceeding the threshold intensity. In some embodiments, the change of appearance may be detectable by the eye of a human observer. In some embodiments, the change of appearance may be detectable by the unaided eye of a human observer. In some embodiments, the threshold intensity is lower than the intensity necessary to damage the seal. In all embodiments, inspecting the seal device 10a may be carried out at least partially using visual inspection to determine the change in the appearance of at least some of its thermochromic material.

The color change can be a permanent shift in the one or more frequencies absorbed or a reversible shift that slowly or quickly reverts back to absorbing appropriate frequencies for the initial temperature. The type of thermochromic material mixed with the seal material may be based on the process for verification of seal quality. Thus, a one embodiment includes a permanent or irreversible thermochromic material. An irreversible thermochromic material may be configured to retain the coloration change upon exposure to excess temperatures, which may be generally an indication of the highest temperature reached by the seal material during the seal operation. In this manner, permanent thermochromic material may provide a mechanism for replacing the seal device 10b after detection of the seal device 10b having been exposed to a higher than acceptable temperature. Other embodiments may include a reversible thermochromic material. A reversible thermochromic material may be configured to reverse the changed characteristic (e.g., color change) when the stress to the seal has ceased. This would allow for a visual inspection of a change in characteristic while the seal is in place and in use during operation (e.g., while an engine is running), but also allow for the characteristic change to reverse when not in operation (e.g., when the engine is off and cool again). In some embodiments, the thermochromic compound is a UV thermochromic ink

In further exemplary embodiments, at least a portion of the characteristic changing material is a piezochromic material. Piezochromic materials are compounds or dyes which, upon exposure to different compressive or tensile forces, alter or shift the frequencies of light which they absorb. Thus, piezochromic material would desirably be included in the seal device 10a in applications where the seal device 10a was in compressive or tensile stress. In preferred embodiments, the piezochromic material may be configured to change its appearance when the seal device 10a is exposed to mechanical stress exceeding a threshold intensity. Using the tab member 14a, the seal device 10a may be inspected from the exterior for a change in the appearance of at least some of its piezochromic material that is characteristic of exposure of the seal to mechanical stress exceeding a threshold intensity or stress level. For instance, where the seal device 10a material includes piezochromic material, at least a portion of the seal device 10a may not be activated before at least a portion of the seal is exposed to mechanical stress exceeding the threshold intensity.

In any embodiment, the piezochromic material or compound may include one or more of piezochromic pigments or dyes that exhibit a change in absorption spectrum through changes in the pressure applied to them. Thus, at least a portion of the seal device 10a may change its appearance by developing or changing color after exposure to a mechanical stress exceeding a threshold intensity. Accordingly, the color of at least a portion of the piezochromic material (and thus, the seal device 10a or at least a portion of the seal device 10a) may be a color other than a usual seal color after at least a portion of the seal is exposed to the mechanical stress exceeding the threshold intensity. For instance, the color of at least a portion of the seal device 10b may be blue after at least a portion of the seal is exposed to the mechanical stress exceeding the threshold intensity. In other embodiments, the color of at least a portion of the seal device 10b may be green after at least a portion of the seal is exposed to the mechanical stress exceeding the threshold intensity. In some embodiments, the change of appearance may be detectable by the eye of a human observer. In some embodiments, the change of appearance may be detectable by the unaided eye of a human observer. In some embodiments, the threshold intensity is lower than the intensity necessary to damage the seal. In all embodiments, inspecting the seal device 10a may be carried out at least partially using visual inspection to determine the change in the appearance of at least some of its piezochromic material.

In some embodiments, the piezochromic material may be irreversible. Irreversible piezochromic material may be adapted so that when the seal device 10a is strained but then returns to its original dimensions, the piezochromic material may be irreversibly changed or at least changed in a way that may be detectable for a period of time after it occurs. Other embodiments may include a reversible piezochromic material. A reversible piezochromic material may be configured to reverse the changed characteristic (e.g., color change) when the stress to the seal has ceased. This would allow for a visual inspection of a change in characteristic while the seal is in place and in use during operation (e.g., while an engine is running), but also allow for the characteristic change to reverse when not in operation (e.g., when the engine is off and cool again). In further embodiments, chemical compounds known as sensitizers could optionally be added to the compounds to change or adjust the amount of stress required to trigger absorption of different light frequencies or cause a color change.

The seal compound containing the characteristic changing material may be processed by a variety of well-known processing techniques. These include extrusion, injection molding, transfer molding, compression molding, solution casting and variations thereof. For instance, the seal compound and the characteristic changing material may be placed in the hopper of a laboratory model injection molding machine for mixing. In all instances, the pressure sensitive, thermally or chemically reactive particulates, dyes, powders or other such mixable substances may be mixed with the seal forming compound such that a uniform or substantially uniform distribution of characteristic changing material may be achieved throughout the entirety of the seal device 10a. The characteristic changing material may alternatively be adsorbed onto or absorbed into seal compounds.

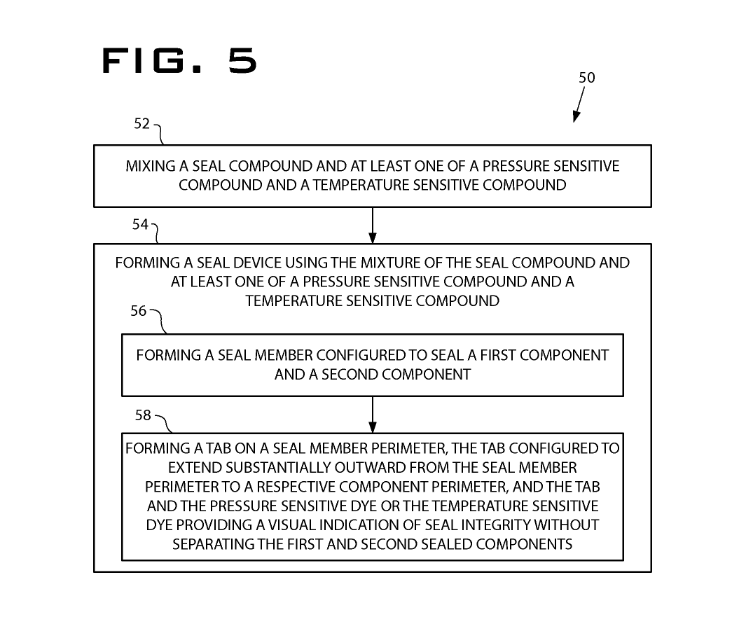

FIG. 5 illustrates a flowchart of a method 50 for forming a seal device providing a visual indication of seal integrity according to embodiments of the present disclosure. Method 50 may include mixing 52 a seal compound and at least one of a pressure sensitive compound and a temperature sensitive compound and forming 54 a seal device using the mixture of the seal compound and the at least one of a pressure sensitive compound and a temperature sensitive compound. Forming 54 the seal device may include forming 56 a seal member configured to seal a first component and a second component, and forming 58 a tab on a seal member perimeter. The tab may be configured to extend substantially outward from the seal member perimeter to a respective component perimeter. The tab and the the pressure sensitive dye and/or the temperature sensitive dye may provide a visual indication of seal integrity without separating the first and second sealed components.

### INDUSTRIAL APPLICABILITY

A seal device 10a as described herein is configured to provide a visual indication of seal integrity. Specifically, the seal device 10a includes a combination of a characteristic changing material mixed with a standard seal compound used to form a seal member 12a and an outward extending seal tab member 14a. The combination of the characteristic changing material and the tab member provide a visual indication that a temperature or pressure limit of the seal has been exceeded without separating the sealed components. Specifically, the seal device 10a in its entirety or the exposed tab member 14a alone may be configured to change colors when the seal is subjected to a temperature or pressure that exceeds a threshold temperature or pressure for the seal device 10a.

The type of early seal failure detection capability described herein has the potential to provide significant savings, reduce repair costs, and prevent productivity losses due to damaged engines. Specifically, a seal can be repaired upon detection that the seal has been compromised and/or before the contained fluid escapes and causes significant damage to the sealed components or machine in high pressure and/or high temperature applications. Such applications include, but are not limited to, hydraulic pumps, motors, actuators, connectors and the like.

It will be apparent to those skilled in the art that various modifications and variations can be made to the disclosed seal device. Other embodiments will be apparent to those skilled in the art from consideration of the specification and practice of the disclosed seal device. It is intended that the specification and examples be considered as exemplary only, with a true scope being indicated by the following claims and their equivalents.

What is claimed is:

1. A seal device comprising:
a seal member configured to seal a first component and a second component; and
a tab member connected to and configured to extend substantially outward from the seal member to a component perimeter, wherein the seal device is formed from a mixture comprising:
a seal compound and a characteristic changing compound, and wherein the tab member is configured to provide a visual indication of seal integrity without separating the first component and the second component.

2. The seal device of claim 1, wherein the seal member is formed as a continuous core of conformable material for placement into a seal channel of one of the first component or the second component to provide a seal between the first component and the second component.

3. The seal device of claim 1, wherein the seal member includes an outer perimeter and an inner perimeter, and the tab member projects substantially away from the outer perimeter and is insertable into a corresponding tab channel formed within the first component and the second component.

4. The seal device of claim 1, wherein the characteristic changing compound is uniformly present within the seal compound.

5. The seal device of claim 1, wherein the seal compound is at least one of a thermoset rubber, cellulose, a polymer, an acrylic, a polyacrylic, and a composite.

6. The seal device of claim 1, wherein the characteristic changing compound is a piezochromic compound configured to change color in response to exposure of the seal device to a mechanical stress higher than a threshold stress level for the seal device.

7. The seal device of claim 6, wherein once the threshold stress level is exceeded, the color change of the piezochromic compound is irreversible.

8. The seal device of claim 1, wherein the characteristic changing compound is thermochromic compound configured to change color in response to exposure of the seal device to a temperature higher than a threshold temperature for the seal device.

9. The seal device of claim 8, wherein once the threshold temperature is exceeded, the color change of the thermochromic compound is irreversible.

10. The seal device of claim 1, wherein the seal device is configured to change from a first color to at least one of blue, yellow, red, green, orange, and purple upon exposure to a mechanical stress higher than a threshold stress level for the seal device or a temperature higher than a threshold temperature for the seal device.

11. A method for visually indicating seal integrity comprising:
mixing a seal compound and characteristic changing compound;
forming a seal device using the mixture of the seal compound and the characteristic changing compound, including:
forming a seal member configured to seal a first component and a second component; and
forming a tab connected to and configured to extend substantially outward from the seal member to a component perimeter, wherein the tab and the characteristic changing compound provide a visual indication of seal integrity without separating the first component and the second component.

12. The method of claim 11, wherein the seal member is formed as a continuous core of conformable material for placement into a seal channel of one of the first component or the second component to provide a seal between the first component and the second component.

13. The method of claim 11, wherein the seal member is formed to include an outer perimeter and an inner perimeter, and the tab member projects substantially away from the outer perimeter and is insertable into a corresponding tab channel formed within the first component and the second component.

14. The method of claim 11, wherein the seal device is configured to change from a first color to at least one of blue, yellow, red, green, orange and purple upon exposure to a mechanical stress higher than a threshold stress level for the seal device or a temperature higher than a threshold temperature for the seal device.

15. The method of claim 12, further including substantially uniformly mixing with the seal compound with the characteristic changing compound to provide a substantially uniform distribution of characteristic changing compound throughout the entirety of the seal device.

16. The method of claim 12, wherein the characteristic changing compound is a piezochromic compound configured to change color in response to exposure of the seal device to a mechanical stress higher than a threshold stress level for the seal device.

17. The method of claim 16, wherein the piezochromic compound is irreversible.

18. The method of claim 11, wherein the characteristic changing compound is thermochromic compound configured to change color in response to exposure of the seal device to a temperature higher than a threshold temperature for the seal device.

19. The method of claim 18, wherein the thermochromic compound is irreversible.

20. A seal device comprising:
a seal member configured to seal a first component and a second component; and
a tab member formed on a seal member perimeter, the tab member configured to extend substantially outward from the seal member perimeter to a respective component perimeter and fit within a corresponding tab channel formed within at least one of the first component and the second component, wherein the seal member and the tab member are formed from a mixture of a seal compound, a pressure sensitive compound, and a temperature sensitive compound, and wherein the tab member is configured to provide a visual indication of seal integrity without separating the first component and the second component.
